(19) United States
(12) Patent Application Publication
(10) Pub. No.: US 2005/0281606 A1
(43) Pub. Date: Dec. 22, 2005

(54) Printer unit

(75) Inventors: Hiroyuki Koyama, Mishlma-shi (JP); Katsumune Hayashi, Suntou-gun (JP); Kouichi Yamada, Tagata-gun (JP)

Correspondence Address: FRISHAUF, HOLTZ, GOODMAN & CHICK, PC, 220 5TH AVE FL 16, NEW YORK, NY, 10001-7708, US

(73) Assignee: Toshiba Tec Kabushiki Kaisha, Tokyo (JP)

(21) Appl. No.: 10/652,924

(22) Filed: Aug. 28, 2003

(30) Foreign Application Priority Data
Aug. 29, 2002 (JP) 2002-251232

(51) Int. Cl. B41J 11/70; B41J 15/02; B41J 15/04

(52) U.S. Cl. 400/621; 400/613; 400/642

(57) ABSTRACT

A printing section has a platen and a printhead which are oppositely located on both sides of a guide path for guiding the paper. A cutter section has a stationary blade and a movable blade located oppositely to either one of the platen and the printhead on both sides of the guide path. At the cutter section, the paper printed at the printing section is cut by engagement between the stationary blade and the movable blade. Either one of the stationary blade and the movable blade is held on a first unit located on one side of the guide path. On the other hand, either the other of the platen and the printhead and either the other of the stationary blade and the movable blade are held on a second unit which is located on the other side of the guide path. That is, the printing section and the cutter section are constructed by thus connecting the first unit to the second unit assembled as described above. Since the second unit is removably connected to the first unit, such components as the printing section and the cutter section can readily be replaced by detaching the second unit from the first unit.

### CROSS REFERENCE TO RELATED APPLICATION

The present application is based on Japanese Priority Document JP-2002-251232 filed on Aug. 29, 2002 the content of which is incorporated herein by reference.

### BACKGROUND OF THE INVENTION

1. Field of the Invention

The present invention relates to a printer unit using a printer for printing on paper which, after printing, will be cut off.

2. Discussion of the Background

Conventionally, there has been adopted a printer in which a roll of paper as a medium to be printed is used, and, after printing, is cut off in an arbitrary position.

As an example of such a printer, there is a receipt printer which is incorporated in a commodity sales-register data processing device such as a POS (Point Of Sales) terminal and an ECR (Electric Cash Register). The printer provides a receipt on which specific data of transaction are printed to make clear details of the transaction by the sales-register processing.

The receipt is issued in accordance with details of transaction. Generally, therefore, the receipt differs in length every time it is issued. In the receipt printer, therefore, the paper is cut by a cutter section as required after printing of specific data, thereby enabling the use of a required length of paper without waste.

The conventional printer stated above will be explained by referring to FIG. 10. A printer 100 is of such a construction that, on a frame 108, are mounted a paper housing section 101 for holding paper, a printing section 104 having a platen 102 which is driven to rotate and a printhead 103 located oppositely to the platen 102, and a rotary cutter 107 which is a cutting section having a stationary blade 105 and a movable blade 106 disposed oppositely to the stationary blade 105 and driven to rotate while sliding its cutting edge section in relation to that of the stationary blade 105.

The frame 108 is constructed with a lower frame 109 and an upper frame 110 rotatably connected on a support shaft 111.

In the printer 100 stated above, when printing is performed, first the upper frame 110 is turned in a direction in which the upper frame 110 moves away from the lower frame 109, whereby the frame 108 is made open. Subsequently, paper 112 is drawn out so as to pass on the lower frame 109. In this state, the upper frame 110 is turned to approach the lower frame 109, thus closing the frame 108. Then the paper 112 is held between the platen 102 and the printhead 103, being set in the printer 100.

In the printer 100 stated above, the upper frame 110 is turned in relation to the lower frame 109 to thereby enable the movement of the platen 102 away from the printhead 103 and accordingly the stationary blade 105 away from the movable blade 106. Therefore, setting of the paper 112 and clearing of jamming of the paper 112 between the platen 102 and the printhead 103 or between the stationary blade 105 and the movable blade 106 can easily be performed.

In the printer 100, however, when the platen 102, the printhead 103, the stationary blade 105 or the movable blade 106 is to be replaced with a new part because of the end of its life, it is necessary to disassemble the printer 100 to remove the old part from the frame 108, which will take time and manpower.

### SUMMARY OF THE INVENTION

Accordingly, an object of the present invention is to enable easy replacement of component parts such as the printing section and the cutter section.

Another object of the present invention is to facilitate paper setting in a printer and also clearing of a paper jam.

The objects of the present invention are achieved by the novel printer unit of the present invention.

According to the novel printer unit of the present invention, a printing section has a platen and a printhead located oppositely on both sides of the guide path; in the printing section, a cutter section has a stationary blade and a movable blade located oppositely on both sides of the guide path and cuts paper printed at the printing section by engaging the movable blade with the stationary blade. A first unit is located on one side of the guide path, holding either one of the stationary blade and the movable blade in the cutter section; and a second unit located on the other side of the guide path has either one of the other platen and the other printhead and either one of the other stationary blade and the other movable blade. The first and second units are detachably connected so as to constitute the printing section and the cutter section in the state that the second unit is connected with the first unit. The component parts such as the printing section and the cutter section, therefore, can readily be replaced by detaching the second unit from the first unit.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a longitudinal left side view showing a receipt printer according to one embodiment of the present invention;

FIG. 2 is a left side view showing the receipt printer according to one embodiment of the present invention;

FIG. 3 is a right side view showing the receipt printer according to one embodiment of the present invention;

FIG. 4 is a perspective view showing a movable blade and a rotating shaft in the receipt printer according to one embodiment of the present invention;

FIG. 5 is a plan view showing the rotating shaft with the movable blade mounted in the receipt printer according to one embodiment of the present invention;

FIG. 6 is a longitudinal left side view showing an upper unit and a lower unit, in a separated state, in the receipt printer according to one embodiment of the present invention;

FIG. 7 is a perspective view showing a printer unit in the receipt printer, with the upper unit and the lower unit connected, according to one embodiment of the present invention;

FIG. 8 is a longitudinal left side view showing the mounting structure of a thermal head and a hook member in the receipt printer according to one embodiment of the present invention;

FIG. 9 is a longitudinal left side view showing a printer unit according to another embodiment of the present invention; and

FIG. 10 is a longitudinal side view showing a conventional printer.

### DETAILED DESCRIPTION OF THE PREFERRED EMBODIMENTS

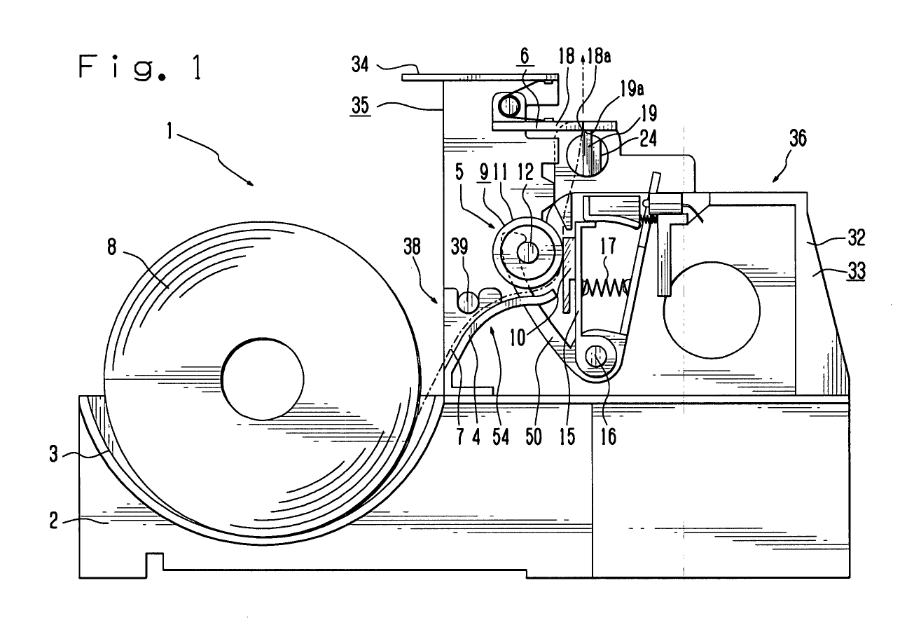

A printer unit according to one embodiment of the present invention will be described with reference to FIG. 1 to FIG. 8. The present embodiment is an example of application of the printer unit to a receipt printer incorporated in a POS terminal or an ECR.

FIG. 1 is a longitudinal left side view showing the receipt printer according to one embodiment of the present invention. The receipt printer 1, as shown in FIG. 1, is comprised of such basic sections of the receipt printer 1 as a support frame 2, a paper holding section 3, a paper guide 4, a printing section 5 and a cutter section 6. In the receipt printer 1, a paper carrying path 7 is formed as a guide path from the paper holding section 3 as a starting point to the cutter section 6 via the printing section 5. The paper holding section 3 is formed circular to hold a roll of long paper 8. The paper guide 4 is formed between the front end of the paper holding section 3 and the printing section 5, to thereby support the surface of the paper 8.

The printing section 5 is provided with a platen 9, and a thermal head 10 which is a printhead located oppositely to the platen 9. The platen 9 comprises a paper support section 11 which supports the back of the paper 8, and a support shaft 12 formed extended out of both ends of the paper support section 11.

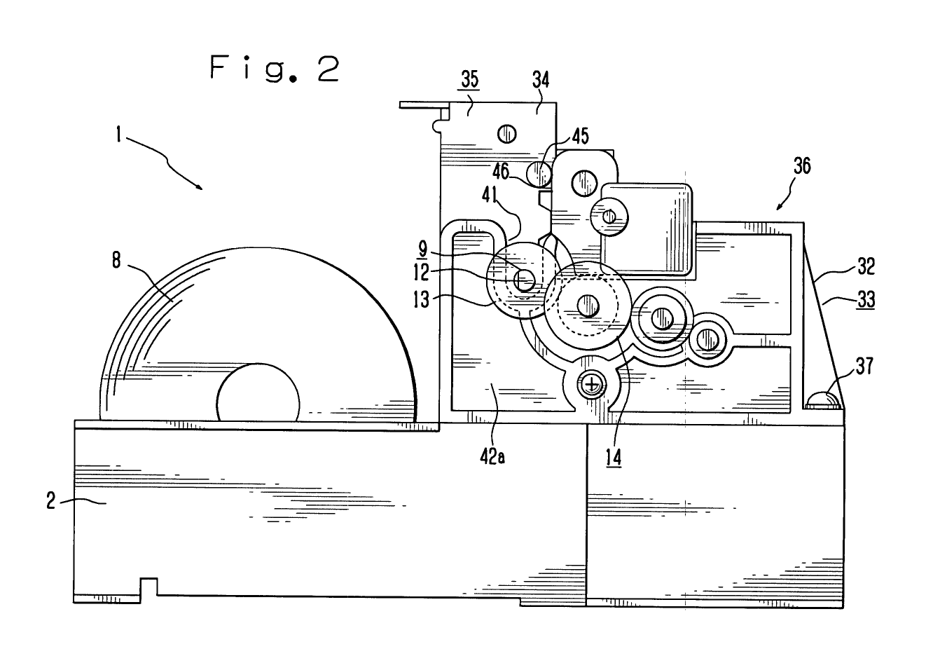

Here, FIG. 2 is a left side view showing the receipt printer. On the support shaft 12 on one end side of the platen 9, a gear 13 is mounted as shown in FIG. 2. The platen 9 is driven by an unillustrated motor to turn on the center of rotation of the support shaft 12 through a gear 13 and a gear train 14 which is in mesh with the gear 13.

The thermal head 10, as shown in FIG. 1, is mounted on a flat plate-shaped head holding member 15. The head holding member 15 is rotatable on the center of a fulcrum 16 in a direction in which it moves toward, and away from, the platen 9. The head holding member 15 is pulled toward the platen 9 by means of a coil spring 17 which functions as a compression spring. The coil spring 17 is mounted between the head holding member 15 and a later-described hook member 50, thereby holding the thermal head 10 in contact with the platen 9.

In the printing section 5, the paper 8 is interposed between the platen 9 and the thermal head 10. Printing is done on the paper 8 by the thermal head 10. Further in the printing section 5, the platen 9 is driven by a motor to turn to carry the paper 8 along the paper carrying path 7. Therefore, the printing section 5 also functions as a carrying section for carrying the paper 8.

The cutter section 6 has an assembly of a stationary blade 18 and a movable blade 19 each of which has a shape of approximately flat plate. These blades 18 and 19 are of a separated type, being kept open when not cutting. The stationary blade 18 and the movable blade 19 are so positioned as to engage with each other like scissors when the movable blade 19 is rotating. That is, the cutter section 6 of the present embodiment is a rotary cutter so constructed as to cut the paper 8 which is carried along the paper carrying path 7, by engaging the stationary blade 18 with the movable blade 19 like a pair of scissors. The movable blade 19 of the cutter section 6 thus constructed is driven by a stepping motor not shown. The stepping motor is actuated in accordance with a start signal.

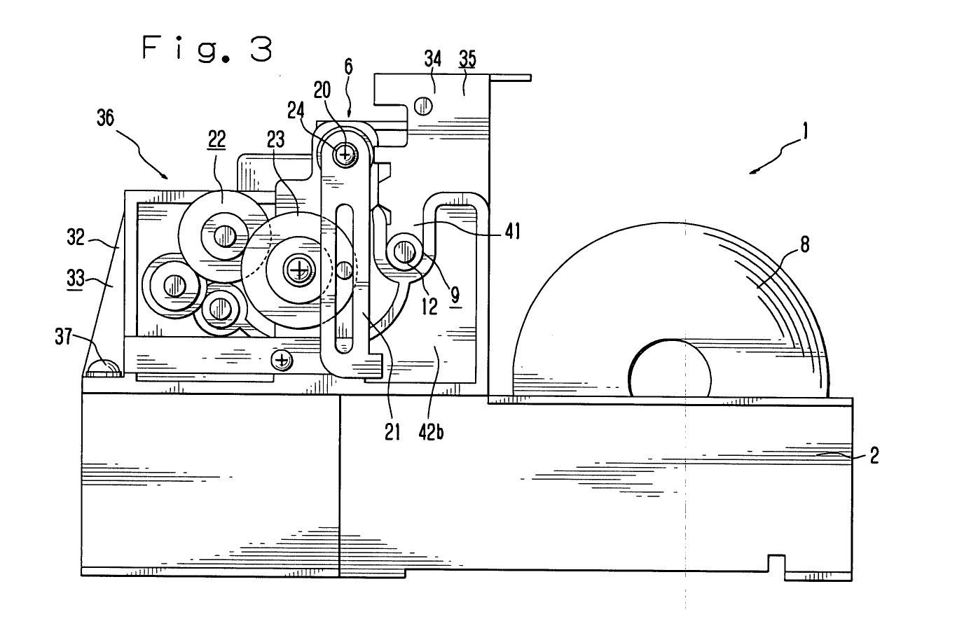

FIG. 3 is a right side view showing the receipt printer. As shown in FIG. 3, a cutter arm 21 which rocks on the center of a fulcrum 20 is connected to the movable blade 19. A driving force of the stepping motor stated above is transmitted to the cutter arm 21 via a plate cam 23 connected through a gear train 22. In the present embodiment, the driving force of the stepping motor is transmitted to the movable blade 19 through the cutter arm 2l, the gear train 22 and the plate cam 23 as power transmission media, thereby driving to rotate the movable blade 19. Here the cutter arm 21 functions as a follower in a cam mechanism in which the plate cam 23 functions as a driver. In the present embodiment, when the cutter arm 21 rocks by a predetermined amount from a predetermined position, the movable blade 19 mounted on a rotating shaft 24 which is a movable blade holding section and is secured on the center of rotation thereof is rotated from a non-cutting position to a cutting position. Thus the paper 8 is cut by the stationary blade 18 and the movable blade 19 which are engaged like scissors.

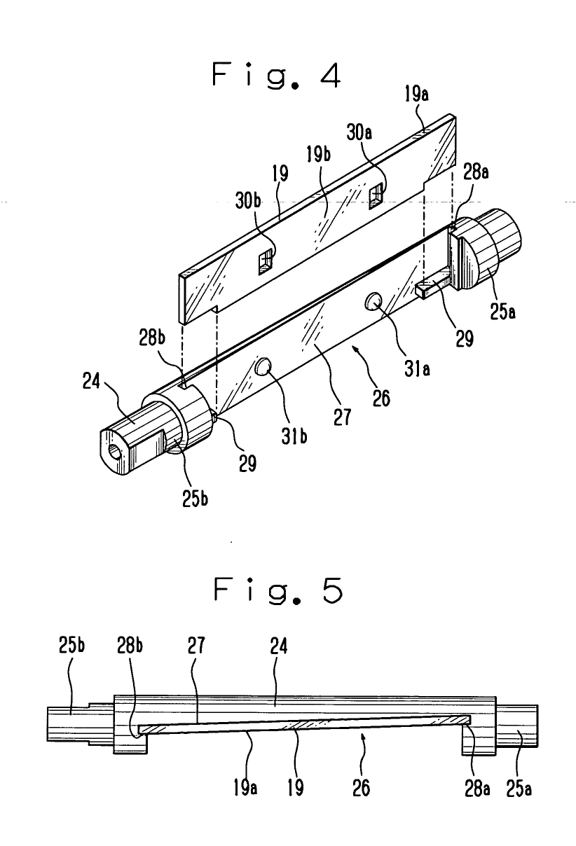

FIG. 4 is a perspective view showing the movable blade and the rotating shaft. FIG. 5 is a plan view showing the rotating shaft mounted with the movable blade. The movable blade 19 is removably mounted on the rotating shaft 24 as shown in FIG. 4. The rotating shaft 24 is produced of an elastic resin, and formed in a shape of rod. Furthermore, the rotating shaft 24 is positioned in a direction in which its axis will be in parallel with the axis of the platen 9.

On both end portions of the rotating shaft 24, support portions 25a and 25b rotatably mounted on the lower unit frame 32 are formed. Between these two support portions 25a and 25b, a movable blade holding section 26 removably holding the movable blade 19 is formed. More specifically, the movable blade holding section 26 is formed as if by cutting out stock between the support sections 25a and 25b in such a manner that the rotating shaft 24 will have a semi-circular cross section. Between the support sections 25a and 25b, a flat surface 27 is formed on the movable blade holding section 26. The flat surface 27 is inclined in relation to the direction of the axis of the rotating shaft 24.

Formed at both ends of the flat surface 27 inside the support sections 25a and 25b are grooves 28a and 28b in which both ends of the movable blade 19 can be slidably fitted. Therefore, the movable blade 19 fitted in the grooves 28a and 28b is inclined in relation to the direction of the axis of the rotating shaft 24 along the flat surface 27. In both ends of the lower edge portion of the flat surface 27, a positioning portion 29 is formed to support the lower edge of the movable blade 19 inserted in the grooves 28a and 28b.

In the base section 19b of the movable blade 19, two holes 30a and 30b are formed. On the flat surface 27 of the rotating shaft 24, two projections 31a and 31b are formed to fit in the holes 30a and 30b. The movable blade 19 is installed in such a manner that an edge portion 19a may protrude out of the outer peripheral surface of the rotating shaft 24, and that the bottom end (the opposite side of the edge portion 19a) of the base section 19b may be in the same position as the outer peripheral surface of the rotating shaft 24. The rotating shaft 24, therefore, can be reinforced by the movable blade 19, thereby maintaining the strength of whole body of the rotating shaft 24 even if the rotating shaft 24 is cut but into a semi-circular cross sectional form.

To mount the movable blade 19 to the movable blade holding section 26, the bottom end on the opposite side of the edge portion 19a of the movable blade 19 is inserted into the grooves 28a and 28b. The rotating shaft, having resilience, deflects to allow the projections 31a and 31b to fit in the holes 30a and 30b. In this state, the movable blade 19 thus fitted in the grooves 28a and 28b is sandwiched between the grooves 28a and 28b which have resilience. Thus fitting the projections in the holes 30a and 30b can restrict the movement of the movable blade 19, holding the movable blade 19 on the rotating shaft 24. When removing the movable blade 19 from the rotating shaft 24, the movable blade 19 is pulled out from the grooves 28a and 28b, to thereby deflect the rotating shaft 24 to release the projections 31a and 31b from the holes 30a and 30b. It is, therefore, possible to remove the movable blade 19 from the grooves 28a and 28b of the rotating shaft 24.

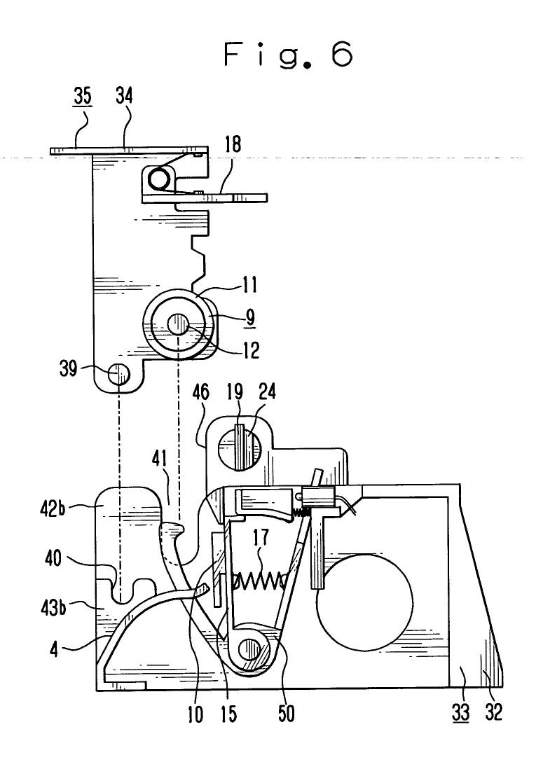

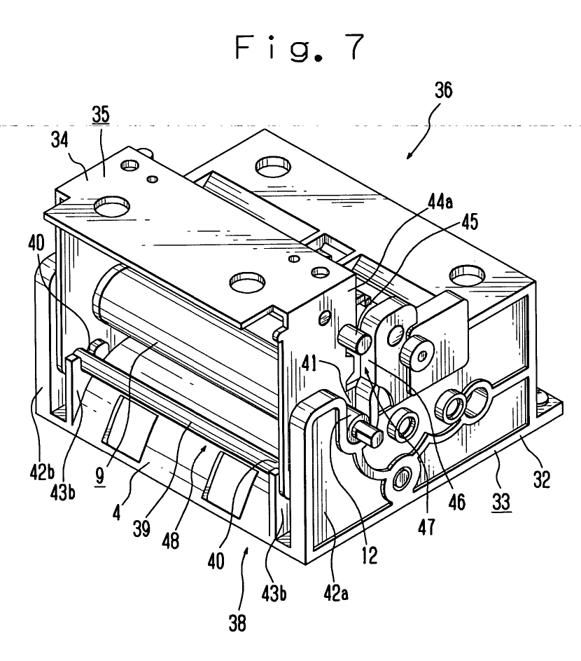

Next, FIG. 6 is a longitudinal left side view showing a printer unit of one embodiment of the present embodiment with an upper unit and a lower unit separated. FIG. 7 is a perspective view showing the printer unit of one embodiment of the present embodiment with the upper unit and the lower unit connected. As shown in FIG. 1, FIG. 6 and FIG. 7, the paper guide 4, the thermal head 10, the movable blade 19, the fulcrum 20, the cutter arm 21, the gear train 22, the plate cam 23, and the gear train 14 are mounted on the lower unit frame 32, forming the lower unit 33 which is the first unit.

On the other hand, the platen 9 and the stationary blade 18 are mounted on a turned square U-shaped upper unit frame 34 which is provided separately from the lower unit frame 32, thereby forming the upper unit 35 as the second unit.

In the present embodiment, a printer unit 36 is comprised of the lower unit 33 and the upper unit 35.

The paper holding section 3 is provided on the support frame 2. A motor for driving the movable blade 19 and a motor for driving the platen 9 are mounted on the lower unit frame 32 though not particularly shown. In FIG. 7, the gear 13 and the gear train 14 are not shown.

The lower unit 33 is installed by a screw 37 to the support frame 2. Therefore, the lower unit 33 is removable from the support frame 2. In the present embodiment, the unit support section is realized by the support frame 2.

The upper unit 35 is removably installed to the lower unit 33 by a connecting mechanism 38. The connecting mechanism 38 is comprised of a connecting shaft 39 and the support shaft 12 of the platen 9 both mounted on the upper unit frame 34 of the upper unit 35, a groove 40 formed as a support section in the lower unit frame 32 of the lower unit 33 in which the connecting shaft 39 can be fitted, and a groove 41 formed as a support section in the lower unit frame 32 of the lower unit 33 in which the support shaft 12 of the platen 9 can be fitted.

The connecting shaft 39 is located on the upstream side of the platen 9 in the direction in which paper is carried. The direction of the axis of the connecting shaft 39 is in parallel with the direction of the axis of the platen 9 which is the direction of paper width.

The groove 40 is formed in a pair of inside walls 43a and 43b formed vertically inside of both side walls 42a and 42b of the lower unit frame 32. The groove 40 is open at the upper part. The groove 41 is formed in both side walls 42a and 42b of the lower unit frame 32, and opens at the upper part.

In the connecting mechanism 38, when the connecting shaft 39 and the support shaft 12 of the platen 9 fit in the grooves 40 and 41 respectively, the upper unit 35 is positioned in relation to the lower unit 33, thereby connecting the upper unit 35 to the lower unit 33. In this state, the upper unit 35 is secured to the lower unit 33 so as to restrict the movement of the upper unit 35 in relation to the lower unit 33. The support shaft 12 of the platen 9 functions also as a connecting shaft together with the connecting shaft 39. In the state of connection, the platen 9 and the thermal head 10 are oppositely positioned, and the gear 13 mounted on the platen 9 meshes with the gear train 14 as shown in FIG. 2. The movable blade 19 and the stationary blade 18 are positioned in a position in which the paper 8 can be cut.

In the upper unit frame 34, a connecting shaft 45 is disposed. On the lower unit frame 32, a vertical wall 46 is formed. The connecting shaft 45 and the vertical wall 46 are so constructed as to be in contact with each other when the upper unit 35 and the lower unit 33 are connected. To give a more detailed description, the axis of the connecting shaft 45 is in parallel with the axis of the platen 9, so that the connecting shaft 45 extends sideward from the outer surface of one side wall 44a of the upper unit frame 34. Furthermore, the connecting shaft 45 is installed with its front side in contact with the rear surface of the vertical wall 46 where the upper unit 35 and the lower unit 33 are in a connected state. In the present embodiment, the support section is realized by the vertical wall 46, and the connecting shaft fitted to the support section is realized by the connecting shaft 45. The connecting mechanism 38 is partly constituted of the connecting shaft 45 and the vertical wall 46.

In the present embodiment, a plurality of connecting shafts are realized by the support shaft 12 of the platen 9, the connecting shaft 39, and the connecting shaft 47. Also a plurality of support sections are realized by the grooves 40 and 41 and the vertical wall 47.

A clearance between a pair of inside walls 43a and 43b formed in the lower unit frame 32 is set narrower than that between the both side walls 44a and 44b of the upper unit frame 34. When the upper unit 35 is connected to the lower unit 33, a pair of inside walls 43a and 43b of the lower unit frame 32 are inserted between the side walls 44a and 44b of the upper unit frame 34, thereby guiding the lateral position of the upper unit 35 in relation of the lower unit 33.

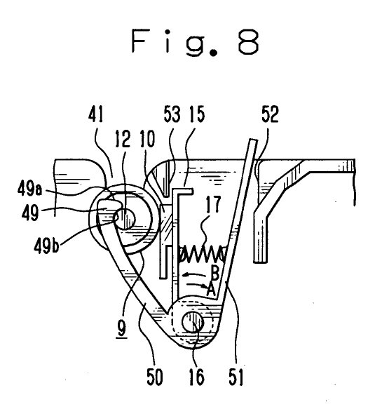

FIG. 8 is a longitudinal left side view showing the mounting construction of the thermal head 10 and the hook member. As shown in FIG. 8, a pair of hook members 50 are installed on the lower unit 33. Formed on either of the hook members 50 is a hook portion 49, which can be engaged with, and disengaged from, the support shafts 12 of the platen 9 fitted in the groove 41. The hook member 50 is composed of the hook portion 49 and a flat plate portion 51 formed in a shape of flat plate unitarily with the hook portion 49. The flat plate portion 51 serves also as a lever for unlocking the hook portion 49. The hook member 50 is rotatable about the fulcrum 16 in a direction in which the hook portion 49 is engaged with, and disengaged from, the support shafts 12 of the platen 9. The hook member 50 is being pressed toward engagement with the support shafts 12 of the platen 9 (in the direction of arrow A in FIG. 8) by the coil spring 17 arranged between the hook member 50 and the head holding member 15.

On the hook portion 49, an inclined portion 49a and an inclined portion 49b are formed. The inclined portion 49a is inclined to allow the rotation of the hook member 50 to thereby prevent interference with the support shafts 12 while abutting against the support shafts 12 of the platen 9 when the upper unit 35 is installed to the lower unit 33. The inclined portion 49b is inclined to allow the rotation of the hook member 50 to thereby prevent interference with the support shafts 12 while abutting against the support shafts 12 of the platen 9 when removing the upper unit 35 from the lower unit 33.

When the upper unit 35 is connected to the lower unit 33, the interference of the hook member 50 with the support shafts 12 of the platen 9 is prevented by rotating the hook member 50 against an urging force of the coil spring 17 as the upper unit 35 approaches the lower unit 33. Finally, however, the hook portion 49 is moved to engage the support shafts 12 of the platen 9 by the force of the coil spring 17, thus locking the upward movement of the upper unit 35 in relation to the lower unit 33. In the state that the upper unit 35 is installed on the lower unit 33, the coil spring 17 urges the thermal head 10 into contact with the platen 9 body.

When the upper unit 35 is removed from the lower unit 33, the interference of the hook member 50 with the support shafts 12 of the platen 9 is prevented by rotating the hook member 50 against the urging force of the coil spring 17 as the upper unit 35 moves away from the lower unit 33. Finally, the hook member 49 is released from the support shafts 12 of the platen 9.

In the state that the upper unit 35 is off the lower unit 33, the hook member 50 being pressed by the coil spring 17 and the head holding member 15 are positioned in contact with positioning surfaces 52 and 53 formed on the lower unit frame 32.

In the state that the upper unit 35 and the lower unit 33 are connected, the connecting shaft 39 is positioned adjacently to the paper guide 4, supporting the paper 8 on the back side. In the receipt printer 1 of the present embodiment, a paper smoothing section 54 comprises the aforementioned connecting shaft 39 and the paper guide 4 as shown in FIG. 1. In the paper smoothing section 54, the roll of paper 8 being fed out is sandwiched from above and from below between the connecting shaft 39 and the paper guide 4, thus being smoothed. Here, the paper 8 wound in a form of roll tends to curl in the vicinity of the trailing end thereof due to a curling tendency, but can be straightened by passing through the paper smoothing section 54.

According to the construction mentioned above, when the paper 8 is set on the receipt printer 1, the upper unit 35 must be removed first. Concretely, the upper unit 35 is moved upward to thereby unlock the hook member 50 from the platen 9, thus disconnecting the connecting mechanism 38. Then the upper unit 35 is ready for removal from the lower unit 33.

When the paper 8 is set on the receipt printer 1, the flat plate portion 51 is operated to turn the hook member 50 toward unlocking (in the direction of arrow B in FIG. 8), thereby also enabling the unlocking of the platen 9 by the hook member 50. It is needless to say that the platen 9 can be unlocked without performing the unlocking operation.

With the upper unit 35 removed from the lower unit 33, the paper 8 is set in the paper holding section 3 and the leading end of the paper 8 is pulled out downstream in the direction of travel of the paper 8 beyond the movable blade 19.

Subsequently, the upper unit 35 is moved toward the lower unit 33 so that the connecting shaft 39 and the support shaft 12 of the platen 9 fit in the grooves 40 and 41. Then, the upper unit 35 and the lower unit 33 are connected. At this time, the connecting shaft 45 comes into contact with the vertical wall 46 and the hook member 50 locks the platen 9.

With the connection of the upper unit 35 and the lower unit 33, the paper 8 is passed through between the connecting shaft 39 and the paper guide 4, between the thermal head 10 and the platen 9, and then between the stationary blade 18 and the movable blade 19.

In the present embodiment, because the upper unit 35 is removably mounted to the lower unit 33, and such opposed members as the thermal head 10 and the platen 9 and the stationary blade 18 and the movable blade 19 with the paper carrying path interposed therebetween are provided in the upper unit 35 and the lower unit 33, the paper 8 can easily be set to the receipt printer 1. Furthermore, a paper jam can easily be cleared.

At the time of printing, the paper 8 held in the paper holding section 3 is fed out by the platen 9, advancing in the paper carrying path 7 toward the printing section 5, where predetermined data of receipt are successively printed on the paper by the thermal head 10, and then toward the cutter section 6. After printing is finished, the trailing end of the paper 8 is cut by the movable blade 19 of a cutting apparatus; the paper 8 thus cut is issued as a receipt.

Thereafter, as a remaining part of the paper 8 decreases with the issue of receipts, the rolled portion of the paper 8 becomes lightweight, and an increased curling tendency appears In such a case, the paper 8 is likely to move up in the paper holding section 3 to thereby become level and flat on the whole, being fed out in this state. In the present embodiment, however, because of the provision of the paper smoothing section 54, the paper 8 is smoothed by the paper smoothing section 54. In the smoothed state, the paper 8 can be fed into the printing section 5.

In case of jamming of the paper 8 at the paper smoothing section 54, or at the printing section 5, or at the cutter section 6, the upper unit 35 is removed from the lower unit 33 by the same procedure as in the above-described setting of the paper 8. In this state, the space between the connecting shaft 39 and the paper guide 4, and between the thermal head 10 and the platen 9, and between the stationary blade 18 and the movable blade 19, is opened, to thereby enable easy clearance of jams of the paper 8.

Because of the unitization of the platen 9 and the stationary blade 18 into the upper unit 35 and the unitization of the thermal head 10 and the movable blade 19 into the lower unit 33, the setting of the paper 8 and the clearance of paper jams can be carried out more easily and more quickly than in the case where paper setting and jam clearance are performed by independently removing and installing the components stated above.

Furthermore, when the platen 9 or the stationary blade 18 has reached the end of life, the upper unit 35 including a member at the end of life is removed from the lower unit 33, to thereby enable the replacement of the upper unit 35 with a new part.

Furthermore, when the thermal head 10 or the movable blade 19 has reached the end of life, the upper unit 35 is removed from the lower unit 33 and at the same time the screw 37 is removed to allow the removal of the lower unit 33 from the support frame 2. Thus the lower unit 33 can be replaced with a new part.

In the present embodiment, therefore, since the upper unit 35 is designed to be removable from the lower unit 33 and also the lower unit 33 is removable from the support frame 2, a part included in the unit 33 or 35 can readily be replaced by replacing these unit 33 or 35.

The lower unit 33, which is a unit having the movable blade 19 has the rotating shaft 24, that is, a movable blade holding section, for holding the movable blade 19. The movable blade 19 is removable from the rotating shaft 24. Therefore, when the movable blade 19 has reached the end of life, it is possible to easily replace the movable blade 19 alone by removing the movable blade 19 from the rotating shaft 24.

In the meantime, the conventional printer 100 as shown in FIG. 10 is of the unitary construction that the platen 102, the printhead 103, the stationary blade 105, and the movable blade 106, are unitarily mounted on the frame. Finally, therefore, it is necessary to assemble the printer 100 in the same assembly plant, then to ship and sell it. The receipt printer 1 of the present embodiment, however, is of a separable design that the platen 9 and the stationary blade 18 are mounted on the upper unit 35, while the thermal head 10 and the movable blade 19 are mounted on the lower unit 33. Therefore, the upper unit 35 and the lower unit 33 can be assembled in separate assembly plants, and can be separately shipped and sold.

In the receipt printer 1 of the present embodiment, the platen 9 and the stationary blade 18 are unitarily formed as the upper unit 35, and the thermal head 10 and the movable blade 19 are also unitarily formed as the lower unit 33. Therefore, the platen 9, the thermal head 10, the stationary blade 18, or the movable blade 19, for instance when to be replaced, can be replaced as a unit. Replacing operation, therefore, can be carried out more easily as compared with replacing the stationary blade 18 or the movable blade 19 separately.

In the present embodiment, the provision of the platen 9 and the stationary blade 18 on the upper unit 35 and the provision of the thermal head 10 and the movable blade 19 on the lower unit 33 have been explained as an example. However, it should be noted that the present invention is not limited thereto, and that these members may be installed to the opposite units 33 and 35.

Further in the present embodiment, the provision of the connecting shafts 39 and 45 on the upper unit 35 and the provision of the grooves 40 and 41 and the vertical wall 46 and the paper guide 4 on the lower unit 33 have been explained as an example. It, however, should be noticed that the present invention is not limited thereto, and that these members may be installed to the opposite units 33 and 35.

In the present embodiment, the connecting mechanism 38 maybe built to such a simple construction that, in the direction of axis which is the direction of width of the paper, the upper unit 35 can be positioned and secured to the lower unit 33 by respectively fitting a plurality of connecting shafts 39 and the platen 9 mounted on any one of the lower unit 33 which is the first unit and the upper unit 35 which is the second unit, in a plurality of grooves 40 and 41 which are support sections formed in the other one of the lower unit 33 and the upper unit 35.

During the cutting operation of the cutter section 6, the stationary blade 18 is pressed by the movable blade 19 which is driven to rotate. It is conceivable, however, that, at this time, if there is only one connecting shaft, that is, the connecting shaft 39 or the platen 9, the upper unit 35 will be turned by a turning moment on the center of the connecting shaft 39 or the platen 9 in relation to the lower unit 33.

In the present embodiment, however, there are employed two connecting shafts: the connecting shaft 39 and the platen 9, the upper unit 35 is fixed to the lower unit 33 by the connecting shaft 39 and the platen 9, being restricted from turning in relation to the lower unit 33 even when there occurs the turning moment on the center of the connecting shaft 39 or the platen 9. Therefore, the upper unit 35 will never be turned by the turning moment.

Furthermore, in the present embodiment, the connecting mechanism comprising the connecting shaft 45 and the vertical wall 46 is located in a higher position than the other connecting mechanism 38. Therefore, when the cutter section 6 in the printer unit 36 which is large in dimensions in the direction of height like in the present embodiment is operating, the upper unit 35 can be more effectively restricted from turning if the turning moment is produced on the upper unit 35. In the printer unit 36 having big dimensions in the direction of height, the connecting shaft 45 and the vertical wall 46 are positioned higher than in the other connecting mechanism 38; therefore the turning of the upper unit 35 can be restricted more effectively.

In the present embodiment, the platen 9 has the paper support section 11 supporting the paper 8 and the support shaft 12 extended from either end of the paper support section 11. One of the connecting shafts 39 serves as the support shaft 12, while the platen 9 is used as a connecting shaft, thereby contributing toward the cost reduction of the receipt printer 1.

In the present embodiment, the paper guide 4 is provided in either the lower unit 33 or the upper unit 35, on the upstream side of the platen 9 in the direction of travel of the paper, to support one side of the paper 8. Of the connecting shafts 39 and 9 (platen), the connecting shaft 39 is mounted in the units 33 or 35 which is not provided with the paper guide 4, with its axis directed orthogonally to the direction of travel of the paper. In this state, the lower unit 33 and the upper unit 35 are connected by the connecting mechanism 38, and the connecting shaft 39 positioned oppositely to the paper guide 4 supports the paper 8 on the other side. That is, the paper 8 can be sandwiched between the connecting shaft 39 and the paper guide 4. Therefore, when the unrolled part of the paper 8 remains curled due to the curling tendency, the paper 8 can be smoothed, being fed to the printing section 5.

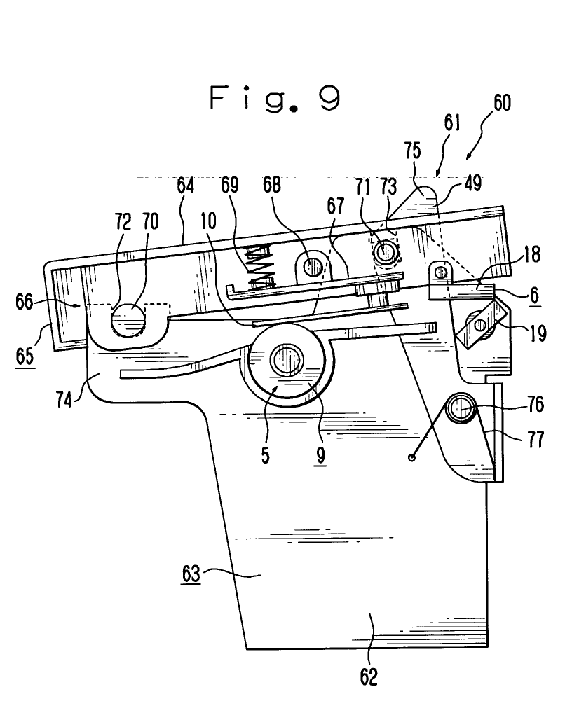

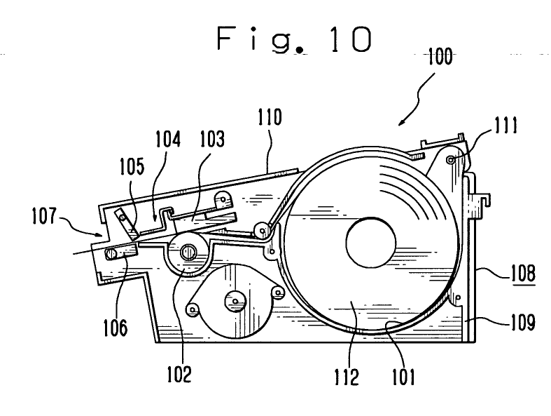

Next, another embodiment of the present invention will be explained with reference to FIG. 9. It should be noted that the same members as those in one embodiment described above are designated by the same reference numerals and will not be described.

FIG. 9 is a longitudinal left side view showing a printer unit of the present embodiment. The receipt printer 60 of the present embodiment, as shown in FIG. 9, differs from one embodiment in the construction of a printer unit 61. In the printer unit of the present embodiment, more specifically, the platen 9 is mounted on a lower unit frame 62 to thereby constitute a lower unit 63. On the other hand, the thermal head 10 is mounted on an upper unit frame 64, thereby constituting an upper unit 65.

The thermal head 10 is mounted on a head holding member 67. The head holding member 67 is rotatable about a fulcrum 68 in a direction in which it approaches, and moves away from, the platen 9. The head holding member 67 is being pressed to the platen 9 by a coil spring 69 which functions as a compression spring. Thus the thermal head 10 is in contact with the platen 9.

The printer unit of the present embodiment is provided with a connecting mechanism 66 which is different from that of the above-described embodiment. The connecting mechanism 66 is comprised of two connecting shafts 70 and 71 provided in the upper unit frame 64, a groove 72 formed in the lower unit frame 62 as a support section in which both ends of the connecting shaft can be fitted, and a groove 73 formed in the lower unit 62 as a support section in which both ends of the connecting shaft 71 can be fitted. The connecting shafts 70 and 71 are mounted at the front and rear of the upper unit frame 64, with their axes directed in parallel with the direction of the axis of the platen 9. The grooves 72 and 73 are formed, open at the upper part, in a pair of inside walls 74 (an inside wall only on one side is shown) formed vertically inside of both side walls (not shown) of the lower unit frame 62. In the connecting mechanism 66, the upper unit 65 is positioned in relation to the lower unit 63 by fitting the connecting shafts 70 and 71 in the grooves 72 and 73, thus connecting the upper unit 65 to the lower unit 63. In this state, the upper unit 65 is secured to the lower unit 63 to restrict the rotation of the upper unit 65 in relation to the lower unit 63.

On the lower unit 63 a hook member 75 is provided. On the hook member 75 is formed the hook portion 49, which can be engaged with, and disengaged from, the connecting shaft 71 fitted in the groove 73. The hook member 75 is designed in such a manner that the hook 49 is rotatable on the center of a fulcrum 76 toward engagement with, and disengagement from, the connecting shaft 71. The hook member 75 is being pressed by a spring 77 toward engagement with the connecting shaft 71, functioning similarly to the hook member 50 of one embodiment.

Therefore, it is possible to provide the printer unit 61 of the above-described construction which incorporates the plates 9 mounted on the lower unit 63 and the thermal head 10 mounted on the upper unit 65.

Obviously, numerous modifications and variations of the present invention are possible in light of the above teachings. It is therefore to be understood that within the scope of the appended claims, the invention may be practiced otherwise than as specifically described herein.

1. A printer unit, comprising:
a guide path which guides paper;
a printing section having a platen and a printhead located oppositely with the guide path interposed therebetween;
a cutter section which has a stationary blade and a movable blade located oppositely with the guide path interposed therebetween and cuts paper printed at the printing section by engaging the movable blade with the stationary blade;
a first unit located on one side of the guide path and having either one of the platen and the printhead and either one of the stationary blade and the movable blade;
a second unit located on the other side of the guide path and having either one of the other platen and the other printhead and either one of the other stationary blade and the other movable blade; and
a connecting mechanism which removably connects the first unit to the second unit so as to construct the printing section and the cutter section in the state that the second unit is connected with the first unit.

2. A printer unit according to claim 1, further comprising a unit support section which removably supports the first unit.

3. A printer unit according to claim 1, wherein the connecting mechanism has a plurality of connecting shafts mounted in one of the units, with the axes thereof directed orthogonally to the direction of guide of the paper along the guide path, and a plurality of support sections provided in the other unit in which the fitting of the connecting shafts is allowed.

4. A printer unit according to claim 3, wherein the platen has a paper support section which supports the paper and a support shaft extended from either end of the paper support section to serve as one of the connecting shafts.

5. A printer unit according to claim 3, further comprising a paper guide which is located in one of the units and supports one side of the paper on the upstream side of the platen in the direction of travel of the paper; and
wherein one of the connecting shafts is located oppositely to the paper guide so that, with the first unit and the second unit connected by the connecting mechanism, the paper will be sandwiched between the connecting shaft and the paper guide.

6. A printer unit according to claim 1, further comprising a movable blade holding section which is mounted on the unit holding the movable blade, and removably holds the movable blade.

7. A printer unit according to claim 2, further comprising a screw for securing the first unit to the unit support section by threaded engagement between the unit support section and the first unit.
